(19) United States
(12) Patent Application Publication
(10) Pub. No.: US 2025/0130377 A1
(43) Pub. Date: Apr. 24, 2025

(54) MULTI-FIBER CONNECTOR STRUCTURALLY CONFIGURED TO PROVIDE A REDUCED FOOTPRINT AND CABLE VOLUME

(71) Applicant: Belden Canada ULC, Saint-Laurent (CA)

(72) Inventor: MASSIMO P. CARBONI, Montreal (CA)

(73) Assignee: Belden Canada ULC, Saint-Laurent (CA)

(21) Appl. No.: 18/920,586

(22) Filed: Oct. 18, 2024

Related U.S. Application Data
(60) Provisional application No. 63/544,666, filed on Oct. 18, 2023.

(51) Int. Cl. G02B 6/38

(52) U.S. Cl. CPC G02B 6/3887; G02B 6/3885

(57) ABSTRACT

A multi-fiber connector may include a body portion configured to receive a multi-fiber cable, and a connector portion structurally configured to extend from the body portion. The connector portion may include a plurality of fiber optic connector portions, and each of the fiber optic connector portions may be structurally configured to terminate a fiber of the multi-fiber cable. Each fiber optic connector portion may include a connector sub-assembly portion, and the body portion may include a plurality of sub-assembly receiving portions configured to receive one of the connector sub-assembly portions therein. Each fiber optic connector portion may be structurally configured to couple one of the connector sub-assembly portions with a respective sub-assembly receiving portion of the plurality of sub-assembly receiving portions. The body portion and the connector portion may be configured to be coupled together to form a single unibody that is configured to provide a plurality of fiber optic connections in a reduced footprint and with reduced cable volume.

### CROSS-REFERENCE RELATED APPLICATION

This application claims the benefit of U.S. Provisional Application No. 63/544,666, filed Oct. 18, 2023, which is currently pending, the disclosure of which is hereby incorporated by reference herein in its entirety.

### TECHNICAL FIELD

The present disclosure is directed to a fiber optic cable connector and, more particularly, to a multi-fiber connector structurally configured to provide a reduced footprint and a reduced cable volume.

### BACKGROUND

As advancements in fiber optic distribution and connectivity have improved, greater volumes of sites are utilizing fiber optic cable for signal and data transmission. The increase in fiber optic use can correlate to heightened volumes of cables, interconnects, and distribution devices that present installation, maintenance, and replacement complexity issues. For instance, increased volumes of fiber optic transmission pathways may result in greater amounts of fiber optic cables and interconnecting adapters that can be difficult to physically organize and orient to provide a desired amount of connection density needed to accommodate user demand.

Past attempts to address physical fiber optic cable density and organization have grouped multiple fiber optic connectors into a static block that is susceptible to forces and stresses interrupting a fiber optic connection. Existing fiber optic connectors additionally require intervening components, such as cassettes, to manage polarity and connection types, which add to the physically complexity of fiber optic distribution networks.

It may be desirable to provide a multi-fiber connector that is structurally configured to provide a reduced footprint and a reduced cable volume. It may also be desirable to provide a fiber optic cable connector that is structurally configured to reduce the risk of interrupting a fiber optic connection due to encountered forces and stresses. In some aspects, it may be desirable to provide a fiber optic cable connector that includes fiber optic connector portions having twelve fiber polarity assigned thereto such that the connector is structurally configured to be used in a cross connect distribution frame or a direct connect distribution frame.

### SUMMARY

In accordance with various aspects of the disclosure, a multi-fiber connector may include a body portion, a cable receiving portion structurally configured to be coupled with the body portion, and a connector portion structurally configured to extend from the body portion. The cable receiving portion may be configured to receive a single multi-fiber cable, the cable receiving portion may include a joining portion configured to be coupled with a retention portion of the body portion, and the connector portion may include a plurality of fiber optic connector portions continuously extending from the retention portion, and wherein each fiber optic connector portion is structurally configured to terminate one fiber from the multi-fiber cable. Each of the fiber optic connector portions may include a connector sub-assembly portion and a front housing portion, each connector sub-assembly portion may include a ferrule holder portion, a biasing portion, and a ferrule held by the ferrule holder portion, and the body portion may include a plurality of sub-assembly receiving portions. Each connector sub-assembly portion may be structurally configured to be coupled with a sub-assembly receiving portion of the body portion, and the biasing portion may be configured to be disposed between the ferrule holder portion and the sub-assembly receiving portion and to bias the ferrule holder portion away from the sub-assembly receiving portion, and each front housing portion may be configured to be coupled with a respective sub-assembly receiving portion to secure the connector sub-assembly portion to the body portion. Each connector sub-assembly portion may be structurally configured to allow independent ferrule movement relative to the sub-assembly receiving portion to mitigate a risk of external force interrupting an optical connection between a connector and the distribution component. The body portion, the cable receiving portion, and the connector portion may be configured to be coupled together to form a single unibody that is configured to provide a plurality of fiber optic connections in a reduced footprint and with reduced cable volume.

In some embodiments of any of the aforementioned connector, each of the fiber optic connector portions may include a Lucent Connector.

In some embodiments of any of the aforementioned connectors, the plurality of fiber optic connector portions may include at least four fiber optic connector portions.

In some embodiments of any of the aforementioned connectors, the plurality of fiber optic connector portions may include twelve fiber optic connector portions.

In some embodiments of any of the aforementioned connectors, the twelve fiber optic connector portions each may have a polarity assigned thereto such that the connector is structurally configured to be used in a cross connect distribution frame or a direct connect distribution frame.

In some embodiments of any of the aforementioned connectors, the respective ferrules of the connector portion may be aligned along a plane.

According to various aspects of the disclosure, a multi-fiber connector may include a body portion, a cable receiving portion structurally configured to receive a single multi-fiber cable and to be coupled with the body portion, and a connector portion structurally configured to extend from the body portion. The connector portion may include a plurality of fiber optic connector portions, and each of the fiber optic connector portions is structurally configured to terminate a fiber. Each fiber optic connector portion may include a connector sub-assembly portion, the body portion may include a plurality of sub-assembly receiving portions, and each connector sub-assembly portion may be structurally configured to be coupled with a respective sub-assembly receiving portion. The body portion and the connector portion may be configured to be coupled together to form a single unibody that is configured to provide a plurality of fiber optic connections in a reduced footprint and with reduced cable volume.

In some embodiments of any of the aforementioned connectors, each of the fiber optic connector portions may be a Lucent Connector.

In some embodiments of any of the aforementioned connectors, the plurality of fiber optic connector portions may include at least four fiber optic connector portions.

In some embodiments of any of the aforementioned connectors, the plurality of fiber optic connector portions may include twelve fiber optic connector portions.

In some embodiments of any of the aforementioned connectors, the twelve fiber optic connector portions each may have a polarity assigned thereto such that the connector is structurally configured to be used in a cross connect distribution frame or a direct connect distribution frame.

In some embodiments of any of the aforementioned connectors, each of the plurality of fiber optic connector portions includes a ferrule, and the ferrules may be aligned along a plane.

In some embodiments, any of the aforementioned connectors may further include a cable receiving portion configured to receive a multi-fiber cable and including a joining portion configured to be coupled with a retention portion of the body portion.

In some embodiments, the joining portion may include an engagement portion, and the retention portion includes a receiving portion; and the body portion may be configured to receive the joining portion, and the receiving portion is configured to receive the engagement portion to secure the cable receiving portion to the body portion.

In some embodiments of any of the aforementioned connectors, each connector sub-assembly portion may include a ferrule holder portion, a biasing portion, and a ferrule held by the ferrule holder portion, and the biasing portion may be configured to be disposed between the ferrule holder portion and the sub-assembly receiving portion and to bias the ferrule holder portion away from the sub-assembly receiving portion.

In some embodiments of any of the aforementioned connectors, each fiber optic connector portion may include a front housing portion that is structurally configured to be coupled with one of the plurality of sub-assembly receiving portions to secure the one of the plurality of connector sub-assembly portions to the body portion.

In some embodiments of any of the aforementioned connectors, each connector sub-assembly portion may be structurally configured to allow independent ferrule movement relative to the sub-assembly receiving portion to mitigate a risk of external force interrupting an optical connection between a connector and the distribution component.

According to various aspects of the disclosure, a multi-fiber connector may include a body portion configured to receive a multi-fiber cable, and a connector portion structurally configured to extend from the body portion. The connector portion may include a plurality of fiber optic connector portions, and each of the fiber optic connector portions may be structurally configured to terminate a fiber of the multi-fiber cable. Each fiber optic connector portion may include a connector sub-assembly portion, and the body portion may include a plurality of sub-assembly receiving portions configured to receive one of the connector sub-assembly portions therein. Each fiber optic connector portion may be structurally configured to couple one of the connector sub-assembly portions with a respective sub-assembly receiving portion of the plurality of sub-assembly receiving portions. The body portion and the connector portion may be configured to be coupled together to form a single unibody that is configured to provide a plurality of fiber optic connections in a reduced footprint and with reduced cable volume.

In some embodiments of any of the aforementioned connectors, each of the fiber optic connector portions may be a Lucent Connector.

In some embodiments of any of the aforementioned connectors, the plurality of fiber optic connector portions may include at least four fiber optic connector portions.

In some embodiments of any of the aforementioned connectors, the plurality of fiber optic connector portions may include twelve fiber optic connector portions.

In some embodiments of any of the aforementioned connectors, the twelve fiber optic connector portions each may have a polarity assigned thereto such that the connector is structurally configured to be used in a cross connect distribution frame or a direct connect distribution frame.

In some embodiments of any of the aforementioned connectors, each of the plurality of fiber optic connector portions includes a ferrule, and the ferrules may be aligned along a plane.

In some embodiments, any of the aforementioned connectors may further include a cable receiving portion configured to receive a multi-fiber cable and including a joining portion configured to be coupled with a retention portion of the body portion.

In some embodiments, the joining portion may include an engagement portion, and the retention portion includes a receiving portion; and the body portion may be configured to receive the joining portion, and the receiving portion is configured to receive the engagement portion to secure the cable receiving portion to the body portion.

In some embodiments of any of the aforementioned connectors, each connector sub-assembly portion may include a ferrule holder portion, a biasing portion, and a ferrule held by the ferrule holder portion, and the biasing portion may be configured to be disposed between the ferrule holder portion and the sub-assembly receiving portion and to bias the ferrule holder portion away from the sub-assembly receiving portion.

In some embodiments of any of the aforementioned connectors, each fiber optic connector portion may include a front housing portion that is structurally configured to be coupled with one of the plurality of sub-assembly receiving portions to secure the one of the plurality of connector sub-assembly portions to the body portion.

In some embodiments of any of the aforementioned connectors, each connector sub-assembly portion may be structurally configured to allow independent ferrule movement relative to the sub-assembly receiving portion to mitigate a risk of external force interrupting an optical connection between a connector and the distribution component.

### BRIEF DESCRIPTION OF THE DRAWINGS

Further advantages and features of the present disclosure will become apparent from the following description and the accompanying drawings, to which reference is made.

FIG. 1 conveys a line representation of portions of an exemplary fiber optic system in which assorted embodiments of the present disclosure can be practiced.

FIG. 2 displays a line representation of portions of an exemplary fiber optic connector that may be employed in the system of FIG. 1 in accordance with various embodiments.

FIG. 3 illustrates portions of an exemplary fiber optic cable connector configured in accordance with some embodiments.

FIG. 4 depicts aspects of an exemplary fiber optic cable connector arranged and operated in accordance with assorted embodiments.

FIG. 5 represents portions of an exemplary fiber optic cable connector configured in accordance with various embodiments.

FIG. 6 displays portions of an exemplary fiber optic cable connector arranged and operated in accordance with some embodiments.

FIG. 7 conveys portions of an exemplary fiber optic cable connector configured in accordance with assorted embodiments.

### DETAILED DESCRIPTION

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

To accommodate greater volumes of fiber optic connections, increased numbers of interconnections are necessary. The organization and physical efficiency of such interconnections, along with the corresponding fiber optic cables, has become an emphasized aspect of many distribution nodes, such as switches, servers, and other rack-mounted signal devices. Accordingly, embodiments of the present disclosure are generally focused on providing increased fiber optic cable organization and connectivity that has robust resistance to external forces and stresses.

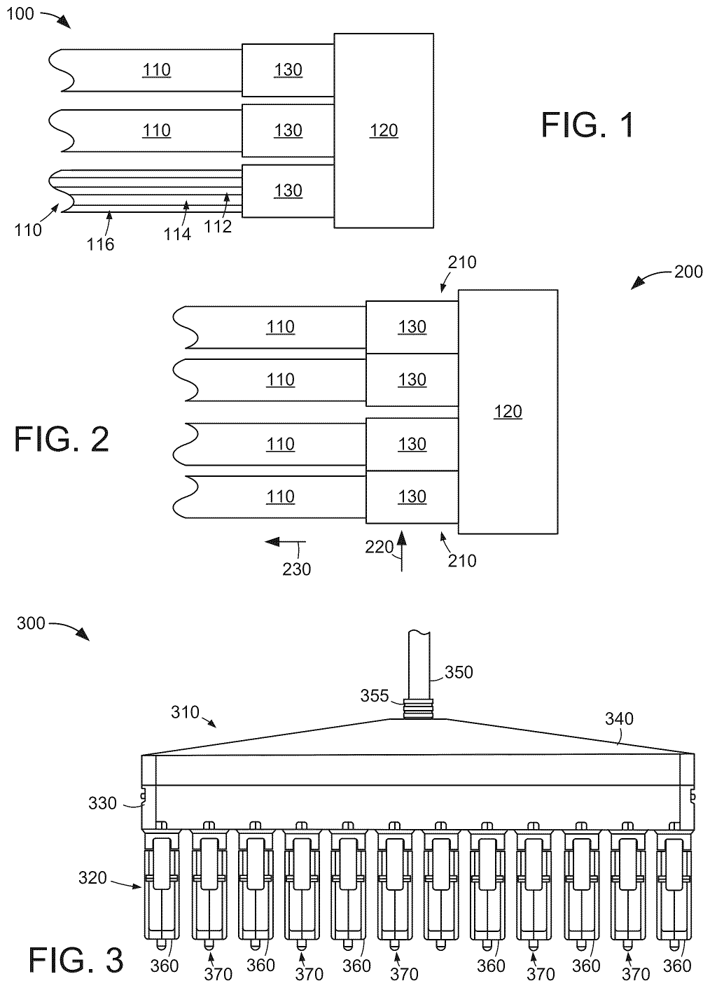

In FIG. 1, a line representation of portions of an example fiber optic system 100 is shown. The system 100 can employ any number of fiber optic cables 110 that respectively connect to an interconnect 120 via a connector 130. While the fiber optic cables 110 can have any diameter, construction, and signal transmission capability, various embodiments configure a cable 110 with a central signal pathway 112 that is surrounded consecutively by an insulator 114 while other embodiments of a cable utilize an outer protective jacket 116 that surrounds the insulator and conductor 112.

The interconnect 120 is not limited to a particular device or component but can be any device or electronic mechanism to alter multiple fiber optic signal pathways. For instance, an interconnect 120 may terminate one cable 110 and begin a new output cable 110. As another example, an interconnect 120 may redirect signals carried by one fiber optic cable 110 to another, different fiber optic cable 110. Regardless of the functional operation, size, capacity, or type of the interconnect 120, the separated configuration of the respective connectors 130, such as a subscriber connector (SC), Lucent connector (LC), straight tip (ST), ferrule connector (FC), multi-fiber push-on (MPO), or very small form factor (VSFF) connectors, can create inefficient and unorganized cable 110 management, particularly over time as different cables 110 are added, removed, or altered.

FIG. 2 is a line representation of portions of an exemplary fiber optic system 200 arranged in accordance with various embodiments to provide increased cable management efficiency and effectiveness. By physically grouping multiple cables 110, the non-limiting embodiment shown in FIG. 2 increases connection density to one or more interconnects 120 as well as heightens cable 110 organization efficiency. That is, the collection of cable connectors 130 into a single unit 210 allows for faster connection to the interconnect 120 and tighter positioning of the cables 110, which allows for greater volumes of connections with the interconnect in the same amount of space as the cable 110 configuration utilized in the system 100 of FIG. 1.

However, the physical collection of connectors into individual units 210 can be increasingly susceptible to physical forces and stresses compared to separately connected cables 110, as shown in FIG. 1. For instance, connecting units 210 that include multiple separate signal conductors from separate cables 110 can inadvertently disconnect from the interconnect 120 in response to physical force in a transverse direction 220 and a longitudinal direction 230. In other words, the physical collection of connectors 130 into a single unit 210 can increase the risk that encountered forces in various directions 220/230 will disrupt or terminate a previously secure fiber optic connection with the interconnect 120.

The physical force susceptibility of connector units 210 having multiple attached connectors 130, along with the lack of more than four connectors 130 efficiently packaged into a single unit 210, prompts various embodiments to configure a fiber optic cable connector with independent suspensions to reduce susceptibility to physical force while concurrently providing more than four fiber optic connector portions 130.

FIGS. 3-7 respectively depict perspective views of assorted aspects of an exemplary fiber optic cable connector assembly 300 that can be employed as part of the fiber optic systems 100/200 of FIGS. 1 and 2 in accordance with various embodiments. Referring to the top perspective view of FIG. 3, the connector assembly 300 includes a body portion 310 that continuously extends into a connector portion 320. The body portion 310 may comprise a single monolithic structure of unitary construction. The body portion 310 includes a retention portion 330 that physically couples with a cable receiving portion 340 to define a collective housing that surrounds and protects the separation of fiber optic cores from a trunk cable 350 to the respective connectors 360 of the connector portion 320. In some aspects, the cable receiving portion 340 may comprise a single monolithic structure of unitary construction.

The cable receiving portion 340 is structurally configured to capture and secure the trunk cable 350, which may contain more than one signal pathway, such as fiber optic cores that correspond with a multifiber cable. As such, the cable receiving portion 340 may be configured to crimp onto the jacketed multifiber cable and, thus, may be referred to as a crimp portion or crimp body. In some non-limiting aspects, the trunk cable 350 may comprise four fibers (4F) or twelve fibers (12F), but other multifiber cables configurations are contemplated by this disclosure. The connector portion 320 may include a plurality of separated fiber optic connector portions 360 that may connect to a corresponding port, for example, an LC-type port. The body portion 310, in accordance with some embodiments, may be structurally configured to be cyclically opened and closed by selecting to engage the retention portion 330 with the cable receiving portion 340. When engaged, the body portion 310 may form a unitary structure that protects and guides signal pathways 112 from the trunk cable 350 to the respective connectors 360.

As noted above, the trunk cable 350 may have any number of separate signal conductors, such as fiber optic cores, that can be terminated with a ferrule portion 370 and each connector 360. It is noted that each of the fiber optic connector portions 360 and ferrule portions 370 may be structurally configured as a similar LC-type fiber optic terminal that has quad footprint capabilities, but such configuration is not required or limiting. For instance, one or more of the fiber optic connector portions 360 and ferrule portions 370 may be a different type, have a different signal transmission capability, or have different physical interaction structures than other fiber optic connector portions 360 and ferrule portions 370.

As shown, the cable receiving portion 340 may connect to the trunk cable 350 with a boot 355, for example, a flexible boot, that is structurally configured to mitigate the risk of damage to the trunk cable 350 over time as a result of movement of the cable 350 and/or the body 310. Some embodiments of the boot 355 provide a fully flexible structure that extends an axial distance along the trunk cable 350 continuously from the cable receiving portion 340 of the body portion 310. Other embodiments of the boot 355 may utilize a combination of rigid and flexible materials to provide cable movement that has a reduced risk of damaging the cable 350, or the constituent signal pathways 112, over time as the connector assembly 300 is employed as part of a fiber optic distribution system.

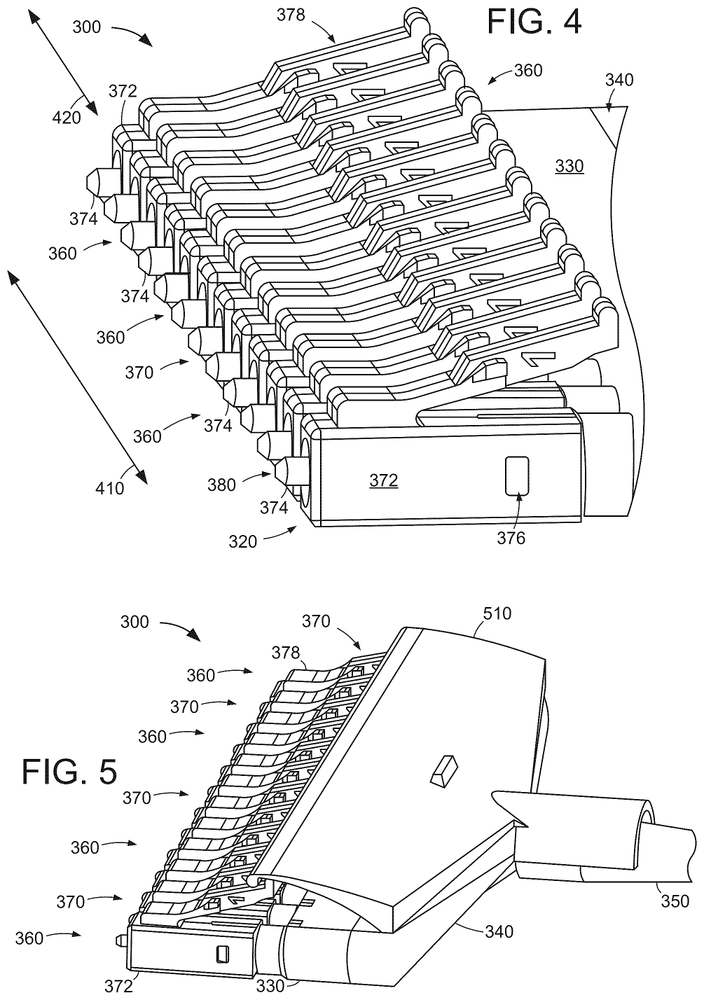

A perspective view of aspects of the connector assembly 300 is illustrated in FIG. 4. It is initially noted how the respective fiber optic connector portions 360 are each aligned along a plane 410. Such arrangement may provide efficient connector density and allow the connector assembly 300 to be utilized in environments with relatively tight space availability. However, the planar alignment of the connectors 360, and specifically the ferrule portions 370 that terminate respective fiber optic cores, is not required as some embodiments stagger the position of the connectors 360 into alignment along separate planes (not shown), such as planes 410 and 420, concurrently. The ability to arrange the respective connectors 360 in different configurations allows the connector assembly 300 to be conducive to physical engagement into different network components, such as servers, switches, and other computing devices.

Although not required or limiting, each fiber optic connector portion 360 has matching dimensions, orientations, and attachment mechanisms. Each connector 360 is structurally configured with a front housing portion 372, for example, an LC-type front housing, that surrounds the ferrule portion 370 and presents a ferrule tip 374. Although not required or limiting, front housing portion 372 may be attached to the body portion 310 via a selectable attachment portion 376 that allows for access to the ferrule portion 370. The attachment portion 376 may be any type, size, and position relative to the housing portion 372 and body portion310, but in some embodiments is a rigid, semi-rigid, or flexible tab that may be manipulated by hand, and/or hand tools, to remove, or install, the housing portion 372 onto the body portion 310.

Each front housing portion 372 may include a selection portion 378, for example, a flexible locking lever, structurally configured to couple the respective fiber optic connector portion 360 with a port, for example, a receptacle, an adapter, or the like. That is, the front housing portion 372 may present structural features, such as the selection portion 378, that allows for efficient physical attachment, and subsequent removal, of a corresponding connector 360 with a port of an external network component. As would be understood by persons skilled in the art, the selection portion 378 may be structurally configured to be physically manipulated when being inserted into a port, and to return toward a rest position once received in the port, to fixedly couple the ferrule tip 374 with the port.

FIG. 5 illustrates another perspective view of the connector assembly 300 constructed and operated in accordance with various embodiments. As shown, the assorted selection portions 378 of the respective front housing portions 372 of the respective connectors 360 may be concurrently engaged by a single actuation portion 510. It is contemplated that an actuation portion 510 may be structurally configured to engage less than all of the selection portions 378 of the connector assembly 300. Other embodiments of the actuation portion 510 may allow multiple sections to be articulated independently of other sections of the actuation portion 510, which may allow for manipulation of particular selection portions 378 without manipulating other selection portions 378 presented in the connector assembly 300.

The actuation portion 510, in some embodiments, may be permanently attached to the body portion 310 and/or trunk cable 350. Other embodiments structurally configure the actuation portion 510 to temporarily attach to the body portion 310, as illustrated in FIG. 5, with aspects that allow for efficient leverage of force to concurrently manipulate each selection portion 378 of the respective connectors 360. The ability to concurrently depress each selection portion 378 with a single application of force on the actuation portion 510 provides efficient and reliable operation compared to individually manipulating selection portions 378.

In some embodiments, the respective connectors 360 may have different front housing portions 372. For instance, the connectors 360 are not limited to having a common connection type, as defined by the front housing portion 372. With the ability to selectively remove and replace a front housing portion 372, the connector assembly 300 may present multiple different connector types concurrently.

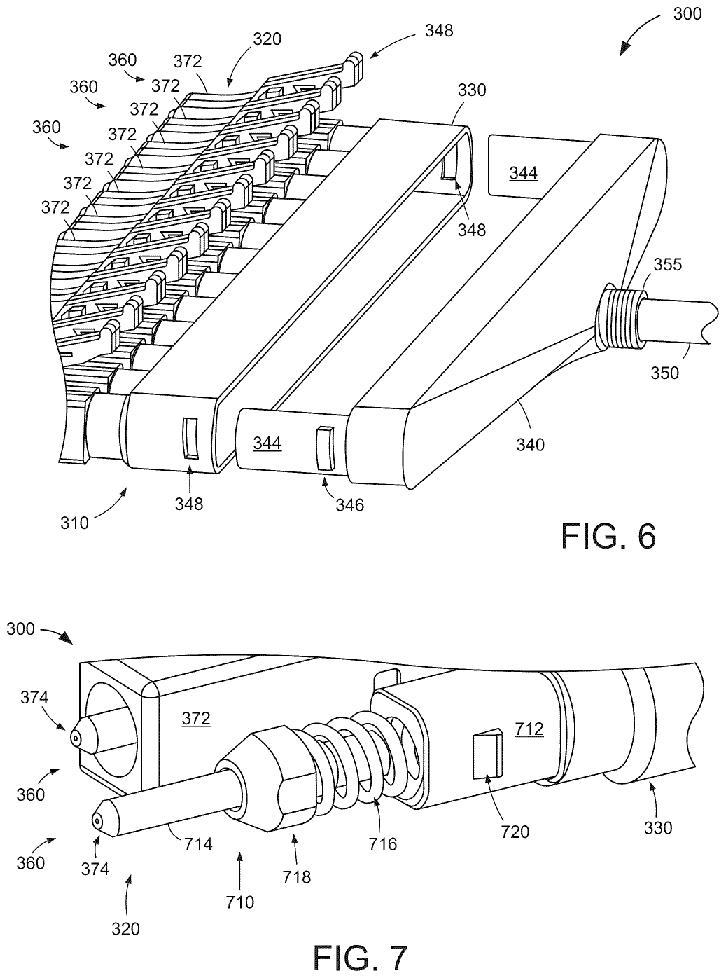

A partially exploded view of the connector assembly 300, as shown in FIG. 6, conveys how the body portion 310 may be arranged to provide a protective inner cavity while allowing for selective access. Some embodiments of the body portion 310 and/or the cable receiving portion 340 may provide structure, such as sidewalls, channels, notches, or posts, to aid in the guidance and/or physically support of the respective fiber optic cores as they migrate from the trunk cable 350 to the connectors 360.

The body portion 310, in accordance with various embodiments, is structurally configured to couple the cable receiving portion 340 with the retention portion 330 via joining portions 344 respectively positioned on opposite lateral sides of the cable receiving portion 340. Each joining portion 344 is a cantilevered member that conforms to the size and shape of the body portion 310 to allow an engagement portion 346, for example, a selectable tab, to engage and occupy a receiving portion 348, for example, a joining opening 348. While concurrent engagement of the tabs 346 of the joining portions 344 with the openings 348 of the retention portion 330 may provide secure physical attachment, the configuration of the body portion 310 shown in FIG. 6 is not required or limiting. As such, different attachment structures, such as keyed protrusions, fasteners, or locking mechanisms, may be employed along with, or instead of, the tabs 346 along any aspect of the body portion 310.

With the structural configuration of the joining portions 344, the inner cavity defined by the body portion may be cyclically assembled and non-destructively disassembled at any time. However, it is noted that some embodiments of the body portion 310 provide a sealed and unitary (i.e., monolithic receptacle) structure that does not allow for selective access, which may promote greater environmental protection of the constituent fiber optic cores than the embodiment shown in FIG. 6.

FIG. 7 illustrates a perspective view of portions of the connector assembly 300 with the front housing portion 372 removed to expose the connector sub-assembly portion 710. In accordance with various embodiments of the connector assembly 300, a selected number of fiber optic connector portions 360, such as, for example, four or more fiber optic connector portions 360 or every fiber optic connector portion 360, terminates a fiber optic signal pathway with a ferrule tip 374. That is, each ferrule tip 374 may correspond with a separated fiber optic core continuously extending from the trunk cable 350 through the the body portion 310 to allow for interaction, and electrical operation with a connected component, such as interconnect 120.

In contrast to physically grouping the fiber optic connector portions 360 into a unitary connector block, the non-limiting embodiments of a connector assembly 300 separate each fiber optic connector portion 360 into independent connector sub-assembly portions 710 that may be independently, and concurrently, manipulated, which mitigates the risk of damage and connection errors as the connector assembly 300 is installed, and subsequently removed, from a network component. For instance, lateral and/or vertical motion of the body portion 310 during installation, operation, or removal of the cable assembly 300 may correspond with forces applied to one or more connector 360 that are mitigated by movement of portions of one or more connector sub-assembly portions 710.

As illustrated in FIG. 7, a connector sub-assembly portion 710 may be physically positioned in a sub-assembly receiving portion 712. The sub-assembly receiving portion 712 continuously extends from the body portion 310 and is hollow to allow a fiber optic core to pass to the ferrule 714 and ferrule tip 374 for optical engagement with a port of an external network component. To allow motion of the ferrule 714 independent of movement of the body portion 310, the connector sub-assembly portion 710 employs a biasing portion 716, such as a spring, damper, or other force absorbing member, to apply continuous force on the ferrule holder portion 718.

It is noted that the connector sub-assembly portion 710 may physically operate with the front housing portion 372, which is secured to the sub-assembly receiving portion 712 by one or more retention tabs 720. The attachment of a front housing portion 372 to the sub-assembly receiving portion 712 is not limited to a particular number, type, or position of physical features. Hence, a retention portion 720, for example, one or more retention tabs, may be utilized to contact and retain aspects of a front housing portion 372, such as a housing aperture, as shown in FIGS. 4 & 5, to allow selective removal, and installation, of the housing portion 372. The ability to cyclically install and remove the front housing portion 372 onto the sub-assembly receiving portion 712 provides access to a connector sub-assembly portion 710 that may allow inspection, repair, and replacement of assorted aspects of the connector sub-assembly portion 710.

With the structural configuration of the connector sub-assembly portion 710, independent axial movement of the respective ferrules 714 promotes efficient damping of forces and maintenance of a secure fiber optic connection despite encountering inadvertent stresses and physical forces. The independent axial motion of the respective connector sub-assembly portions 710 of the respective connectors 360 of the cable assembly 300 may be matching, or dissimilar, to provide uniform, or varying, physical reactions to applied force across the cable assembly 300. That is, connectors 360 expected to experience greater amounts and/or frequency of external force may have a different connector sub-assembly portion 710 components and/or configurations to respond to applied force differently than other connector sub-assembly portions 710 of the cable assembly 300. Regardless of whether the respective connector sub-assembly portions 710 of the cable assembly 300 act uniformly or differently, the risk of encountered stresses and forces disrupting a fiber optic connection is reduced through independent motion of the respective connector sub-assembly portions 710.

It should be understood that the body portion 310, connector portion 320, and/or cable receiving portion 340 may provide a reduced footprint and cable volume relative to a conventional fiber optic cassette, as illustrated in FIG. 3. For example, in a front to rear direction of the connector 300 perpendicular to the plane of the ferrules, a dimension of the portion of the body portion 310 that extends from the sub-assembly receiving portion 712 to the cable receiving portion 340 plus a dimension of the cable receiving portion 340 to a rear end portion that receives a multi-fiber cable 350 may have a dimension that is approximately the same as the dimension of the front housing portion 372 in the same direction. For example, the dimension of the portion of the body portion 310 that extends from the sub-assembly receiving portion 712 to the cable receiving portion 340 plus the dimension of the cable receiving portion 340 to a rear end portion that receives a multi-fiber cable 350 may have a dimension that is approximately the same as the dimension of the LC front housing portion 372. That is, is some aspects, approximately may mean plus or minus 10 percent, such that the dimension of the portion of the body portion 310 that extends from the sub-assembly receiving portion 712 to the cable receiving portion 340 plus the dimension of the cable receiving portion 340 to a rear end portion that receives a multi-fiber cable 350 may have a dimension that is approximately the same as the dimension of the LC front housing portion 372

In operation, manipulation of the biasing portion 716, forces and stresses on the ferrule holder portion 718, the ferrule 714, and the signal conductor extending throughout the ferrule 714 are mitigated to protect the position and integrity of the fiber optic connection provided by the interaction between ferrule 714 and an interconnection receptacle. As such, the cable assembly 300 provides enhanced installation, utilization, and alteration over time. The concurrent, matching configuration of the fiber optic connector portions 360 allows for efficient setup of multiple separate fiber optic connections while the body portion 310 configuration allows for a single, unibody construction that improves cable density and improves cross-connect and direct connect applications by eliminating the need for a cassette to manage fiber optic core polarity. Embodiments of the cable assembly 300 may concurrently provide different types of connectors, such as LC or SC type connectors, as well as customized connector sub-assembly portions 710 that react differently to applied external forces.

It is contemplated that the cable assembly 300 has twelve fiber polarity assigned to each fiber optic connector portion 360. Using the cable assembly 300, in accordance with some embodiments, can eliminate two connection points in a cross-connect, or direct-connect, distribution frame in a fiber optic network architecture. The cable assembly 300, in other embodiments, can eliminate a rack from a dual rack fiber optic distribution area by being plugged directly in front of a cassette.

In one example, a connector according to the disclosure will have the same front housing of an LC connector based on the FOCIS 10-B of TIA. This will allow the connector to be universal to any LC adapter plug. The connector will use a 1.25 mm ferrule, and each ferrule will have its own individual spring following the contact force from the FOCIS 10-B. Each ferrule will be encapsulated around a front housing respecting the TIA LC standards. The body of this connector will be made in 2 parts. The first part will be called the main body and it will be the area where each LC front housing clips onto the connector. This main body will be the area where the ferrule springs will rest against. Behind this main body will be the crimp body. The crimp body will clip onto the main body and provide the crimp area for the jacketed cable to be secured to the connector. The connector will also include a boot on this crimp body, covering the crimp area, and the boot will be flexible to provide movement in the cable exiting the crimp body. The connector may include a mechanism secured to the main body or the crimp body that will allow for the depression of all LC latches on the front housing for easy mating and un-mating of all 12 connectors at the same time. This will be some sort of push/pull feature, or a rod and a tab, or even an external tool.

It should be appreciated that disclosure describes the type of fiber optic connector that uses multiple 1.25 mm ferrules with an LC footprint per the TIA-468 FOCIS 10B standard. The connector has a unibody shape and can be in the form of holding 4×1.25 mm ceramic fiber optic ferrules called a quad-body connector or 12×1.25 mm ceramic fiber optic ferrules called a duodec-body connector. The LC Duplex was invented due to the transmit & receive (Tx & Rx) function of a fiber optic transceiver where 2 LC connectors were required, and thus came the innovation of LC duplex clips and zip cord cable. To reduce the footprint and volume of cable, the uniboot innovation was created to accommodate 1 jacketed cable with 2 fibers inside. The connector now had 1 boot instead of 2 for the zip cord, and most commonly the connector had a “push-pull latch” or a function that can allow you to mate and unmate both plugs in one motion. The connector described herein is an LC Duodec Uniboot and a LC Quad Uniboot that features 4 to 12 LC 1.25 mm ferrules and connector plugs attached to a single “uni-body”.

It should be appreciated that the connector disclosed herein may improve cable density and can use 1 mini-distribution cable that can be as small as 1.9 mm to service 12 fibers, thereby reducing cable volume. The connector disclosed herein is compatible with cross-connect and direct-connect applications. Using this type of Duodec LC connector, the need of a cassette to manage polarity and transitions from LC to MPO trunk cables can be eliminated. The connector disclosed herein has 12 fiber polarity assigned to each connector within the uni-body of the connector plug & can be any polarity. Using this connector in a network architecture eliminates 2 MPO connection points in a cross or direct connect distribution frame. Additionally, The connector disclosed herein can instead eliminate 1 rack from a 2 rack distribution area, and be plugged directly in front of a cassette. As such, the connector disclosed herein improves on the rapidity of installation, for example, it takes 6× less time to make the same number of connections compares to an existing LC duplex connector. The connector disclosed herein also addresses sustainability in the network architecture by using less plastic through the elimination of 2 cassettes and allows for less cable volume.

In summary, connector disclosed herein is the implementation of 4 or more LC style connector plugs in a single uni-body connector. This connector has the highest number of 1.25 mm ferrules housed in a single body that is universally compatible with simple, duplex, or quad LC adapters.

In one example, the connector is the implementation of full 12 fiber TIA standard polarity configurations that can be assigned to an LC style connector. Previously this was only achievable with MT ferrules or with a breakout cable going to individual connectors. This invention allows for 12 fiber polarity in a LC connector that simplifies cross-connect or direct-connection in a distribution frame. This connector eliminates operator error in plugging connectors and can eliminate the need for either 1 rack and patch panel in a distribution area, or an eliminate 1 patch panel with 2 connection and replace it by an adapter frame and 1 connector. The connector may be a type of “rapid deployment cassette” with a much smaller foot print, an LC compatible plug, and can be plugged into any adapter frame or other.

Additional embodiments include any one of the embodiments described above, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A multi-fiber connector structurally configured to provide a reduced footprint and cable volume, comprising:
a body portion;
a cable receiving portion structurally configured to be coupled with the body portion;
a connector portion structurally configured to extend from the body portion;
wherein the cable receiving portion is configured to receive a single multi-fiber cable;
wherein the cable receiving portion includes a joining portion configured to be coupled with a retention portion of the body portion;
wherein the connector portion comprises a plurality of fiber optic connector portions continuously extending from the retention portion, and wherein each fiber optic connector portion is structurally configured to terminate one fiber from the multi-fiber cable;
wherein each of the fiber optic connector portions comprises a connector sub-assembly portion and a front housing portion;
wherein each connector sub-assembly portion comprises a ferrule holder portion, a biasing portion, and a ferrule held by the ferrule holder portion;
wherein the body portion includes a plurality of sub-assembly receiving portions;
wherein each connector sub-assembly portion is structurally configured to be coupled with a sub-assembly receiving portion of the body portion;
wherein the biasing portion is configured to be disposed between the ferrule holder portion and the sub-assembly receiving portion and to bias the ferrule holder portion away from the sub-assembly receiving portion;
wherein each front housing portion is configured to be coupled with a respective sub-assembly receiving portion to secure the connector sub-assembly portion to the body portion;
wherein each connector sub-assembly portion is structurally configured to allow independent ferrule movement relative to the sub-assembly receiving portion to mitigate a risk of external force interrupting an optical connection between a connector and the distribution component; and
wherein the body portion, the cable receiving portion, and the connector portion are configured to be coupled together to form a single unibody that is configured to provide a plurality of fiber optic connections in a reduced footprint and with reduced cable volume.

2. The connector of claim 1, wherein each of the fiber optic connector portions comprises a Lucent Connector.

3. The connector of claim 1, wherein the plurality of fiber optic connector portions comprises at least four fiber optic connector portions.

4. The connector of claim 3, wherein the plurality of fiber optic connector portions comprises twelve fiber optic connector portions.

5. The connector of claim 4, wherein the twelve fiber optic connector portions each have a polarity assigned thereto such that the connector is structurally configured to be used in a cross connect distribution frame or a direct connect distribution frame.

6. The connector of claim 1, wherein the respective ferrules of the connector portion are aligned along a plane.

7. A multi-fiber connector structurally configured to provide a reduced footprint and cable volume, comprising:
a body portion;
a cable receiving portion structurally configured to receive a single multi-fiber cable and to be coupled with the body portion;
a connector portion structurally configured to extend from the body portion;
wherein the connector portion comprises a plurality of fiber optic connector portions, and wherein each of the fiber optic connector portions is structurally configured to terminate a fiber;
wherein each fiber optic connector portion includes a connector sub-assembly portion;
wherein the body portion includes a plurality of sub-assembly receiving portions;
wherein each connector sub-assembly portion is structurally configured to be coupled with a respective sub-assembly receiving portion; and
wherein the body portion and the connector portion are configured to be coupled together to form a single unibody that is configured to provide a plurality of fiber optic connections in a reduced footprint and with reduced cable volume.

8. The connector of claim 7, wherein each of the fiber optic connector portions comprises a Lucent Connector.

9. The connector of claim 7, wherein the plurality of fiber optic connector portions comprises at least four fiber optic connector portions.

10. The connector of claim 9, wherein the plurality of fiber optic connector portions comprises twelve fiber optic connector portions.

11. The connector of claim 10, wherein the twelve fiber optic connector portions each have a polarity assigned thereto such that the connector is structurally configured to be used in a cross connect distribution frame or a direct connect distribution frame.

12. The connector of claim 7, wherein each of the plurality of fiber optic connector portions includes a ferrule, and the ferrules are aligned along a plane.

13. The connector of claim 8, further comprising a cable receiving portion configured to receive a multi-fiber cable and including a joining portion configured to be coupled with a retention portion of the body portion.

14. The connector of claim 13, wherein the joining portion includes an engagement portion, and the retention portion includes a receiving portion; and
wherein the body portion is configured to receive the joining portion, and the receiving portion is configured to receive the engagement portion to secure the cable receiving portion to the body portion.

15. The connector of claim 7, wherein each connector sub-assembly portion comprises a ferrule holder portion, a biasing portion, and a ferrule held by the ferrule holder portion; and
wherein the biasing portion is configured to be disposed between the ferrule holder portion and the sub-assembly receiving portion and to bias the ferrule holder portion away from the sub-assembly receiving portion.

16. The connector of claim 7, wherein each fiber optic connector portion includes a front housing portion that is structurally configured to be coupled with one of the plurality of sub-assembly receiving portions to secure the one of the plurality of connector sub-assembly portions to the body portion.

17. The connector of claim 8, wherein each connector sub-assembly portion is structurally configured to allow independent ferrule movement relative to the sub-assembly receiving portion to mitigate a risk of external force interrupting an optical connection between a connector and the distribution component.

18. A multi-fiber connector structurally configured to provide a reduced footprint and cable volume, comprising:
a body portion configured to receive a multi-fiber cable;
a connector portion structurally configured to extend from the body portion;
wherein the connector portion comprises a plurality of fiber optic connector portions, and wherein each of the fiber optic connector portions is structurally configured to terminate a fiber of the multi-fiber cable; and
wherein each fiber optic connector portion includes a connector sub-assembly portion, and the body portion includes a plurality of sub-assembly receiving portions configured to receive one of the connector sub-assembly portions therein;
wherein each fiber optic connector portion is structurally configured to couple one of the connector sub-assembly portions with a respective sub-assembly receiving portion of the plurality of sub-assembly receiving portions; and
wherein the body portion and the connector portion are configured to be coupled together to form a single unibody that is configured to provide a plurality of fiber optic connections in a reduced footprint and with reduced cable volume.

19. The connector of claim 18, wherein each of the fiber optic connector portions comprises a Lucent Connector.

20. The connector of claim 18, wherein the plurality of fiber optic connector portions comprises at least four fiber optic connector portions.

21. The connector of claim 20, wherein the plurality of fiber optic connector portions comprises twelve fiber optic connector portions.

22. The connector of claim 21, wherein the twelve fiber optic connector portions each have a polarity assigned thereto such that the connector is structurally configured to be used in a cross connect distribution frame or a direct connect distribution frame.

23. The connector of claim 18, wherein each of the plurality of fiber optic connector portions includes a ferrule, and the ferrules are aligned along a plane.

24. The connector of claim 18, further comprising a cable receiving portion configured to receive a multi-fiber cable and including a joining portion configured to be coupled with a retention portion of the body portion.

25. The connector of claim 24, wherein the joining portion includes an engagement portion, and the retention portion includes a receiving portion; and
wherein the body portion is configured to receive the joining portion, and the receiving portion is configured to receive the engagement portion to secure the cable receiving portion to the body portion.

26. The connector of claim 18, wherein each connector sub-assembly portion comprises a ferrule holder portion, a biasing portion, and a ferrule held by the ferrule holder portion; and
wherein the biasing portion is configured to be disposed between the ferrule holder portion and the sub-assembly receiving portion and to bias the ferrule holder portion away from the sub-assembly receiving portion.

27. The connector of claim 18, wherein each fiber optic connector portion includes a front housing portion that is structurally configured to be coupled with one of the plurality of sub-assembly receiving portions to secure the one of the plurality of connector sub-assembly portions to the body portion.

28. The connector of claim 18, wherein each connector sub-assembly portion is structurally configured to allow independent ferrule movement relative to the sub-assembly receiving portion to mitigate a risk of external force interrupting an optical connection between a connector and the distribution component.
